(19) United States
(12) Patent Application Publication
(10) Pub. No.: US 2023/0331903 A1
(43) Pub. Date: Oct. 19, 2023

(54) ADDUCT OF ALKYLATED DIAMINE AND NOVOLAK EPOXY RESIN

(71) Applicant: SIKA TECHNOLOGY AG, Baar (CH)

(72) Inventors: Edis KASEMI, Zürich (CH); Andreas KRAMER, Zürich (CH); Ursula STADELMANN, Zürich (CH); Urs BURCKHARDT, Zürich (CH)

(73) Assignee: SIKA TECHNOLOGY AG, Baar (CH)

(21) Appl. No.: 18/033,720

(22) PCT Filed: Jan. 20, 2022
(86) PCT No.: PCT/EP2022/051225

§ 371 Date: Apr. 25, 2023

(30) Foreign Application Priority Data
Jan. 27, 2021 (EP) 21153823.6

(51) Int. Cl. C08G 59/18; C08G 59/50; C08G 59/24; C09D 163/04; C09D 5/08

(52) U.S. Cl. CPC C08G 59/184; C08G 59/5033; C08G 59/245; C09D 163/04; C09D 5/08; C08G 2150/00

(57) ABSTRACT

An amine-functional adduct from the reaction of at least one amine of the formula (I) with at least one novolak epoxy resin having an average functionality in the range from 2.5 to 4. The adduct is liquid at room temperature without thinners and without a large excess of amine. It is suitable as a curing agent for epoxy resin compositions, in which it permits good workability, rapid curing, high hydrophobicity, and a high crosslinking density. It is particularly suitable for coatings, in which it permits nice surfaces, good intercoat adhesion, high thermal shock resistance, and good protection against steel corrosion.

### TECHNICAL FIELD

The invention relates to amine-functional adducts of monoalkylated diamines and novolak epoxy resins and to the use thereof as curing agents for epoxy resin compositions that are particularly suitable as anti-corrosion coatings.

### PRIOR ART

Epoxy-resin-based coatings or paints for the corrosion protection of steel components are widely used in industry and construction. They consist of a liquid resin component and a curing agent component, which are mixed before application and cure at ambient temperatures in the range from approx. 5 to 40° C. to form a solid coating. The coatings should have low viscosity and cure quickly and unproblematically, forming an even, tack-free surface without haze, spots or deposits, even under cold and damp conditions. They should also have good intercoat adhesion when applied in multiple layers, which is often not the case when surface defects occur as a result of blushing effects, and be particularly robust to corrosive conditions, especially moisture in combination with heat and/or salts. For visually demanding applications, the coatings should also have the lowest possible tendency to yellowing under the influence of light.

Novolak epoxy resins are particularly hydrophobic and permit a high crosslinking density. They are therefore particularly suitable for use in anti-corrosion coatings. In the curing agent component they can be used in the form of adducts with polyamines. However, the amine-functional adducts of novolak epoxy resins known from the prior art are very highly viscous and for working at ambient temperatures usually need to be heavily diluted, typically with thinners such as xylene or benzyl alcohol and/or large amounts of excess polyamine during adduct formation. Since thinners are not incorporated into the resin matrix during curing, they may be released into the environment through evaporation or diffusion processes.

Nowadays, there is however an increasing desire for low-emission products that after curing have a low content of releasable substances. Thinners such as xylene or benzyl alcohol should accordingly be used only in a small amount or not at all.

And high levels of excess polyamine during adduct formation result in increased blushing and reduce the concentration of novolak in the curing agent, diminishing the effect brought about by the hydrophobic component.

U.S. Pat. No. 4,348,505 discloses adducts of polyalkylene amines such as diethylenetriamine (DETA) or primary diamines such as 1,2-diaminocyclohexane with novolak epoxy resins. The adducts produced contain significant amounts of xylene and/or benzyl alcohol.

US 2019/0382524 discloses adducts of bis(6-aminohexyl)amine or triethylenetetramine (TETA) with novolak epoxy resins, which are produced with a high excess of amine.

EP 2 151 461 discloses a mixture of benzylated DETA and TETA and, in example 21, an adduct thereof with a novolak epoxy resin having a high xylene content.

WO 2017/046293 discloses adducts of N-benzylpropane-1,2-diamine or N-benzylethane-1,2-diamine with diepoxides such as bisphenol A diglycidyl ether in particular. Such adducts are significantly less highly functional and hydrophobic compared to adducts of novolak epoxy resins.

### SUMMARY OF THE INVENTION

It is therefore an object of the present invention to provide an amine-functional adduct that at room temperature is liquid and easy to handle even without thinners such as xylene or benzyl alcohol and without a large excess of amine, permits a particularly high crosslinking density, and is thus particularly suitable for use in anti-corrosion coatings.

Surprisingly, this object is achieved by the amine-functional adduct from the reaction of at least one amine of the formula (I) with at least one novolak epoxy resin as claimed in claim 1. Despite the high functionality of the novolak epoxy resin, the adduct according to the invention has surprisingly low viscosity. It has a particularly low odor and at room temperature can be handled in liquid form without a high excess of amine and without thinners. This permits low-odor, low-emission epoxy resin products having a high content of novolak epoxy resin in the curing agent, it being possible, depending on the use and requirements, to flexibly add further amines and/or a thinner when subsequently used. The adduct according to the invention permits epoxy resin coatings that are readily workable at ambient temperatures and cure surprisingly quickly, forming an even, defect-free surface with a low tendency to yellowing. Such coatings are esthetically high-quality, particularly robust to moisture, even in combination with heat and/or salts, and when applied in multiple layers exhibit particularly good adhesion between the layers (intercoat adhesion). In addition, such coatings have high thermal shock resistance—a thin layer of for example 250 μm on steel withstands multiple shock-like temperature changes between ice-water and 200° C. without cracking—which is particularly surprising given the high functionality of the novolak epoxy resin on which the adduct is based.

Further aspects of the invention are the subject of further independent claims. Particularly preferred embodiments of the invention are the subject of the dependent claims.

Ways of Executing the Invention

The invention provides an amine-functional adduct from the reaction of
at least one amine of the formula (I),

Z—NH-A-NH—CH₂—Y (I)
where
A is a divalent alkylene, cycloalkylene or arylalkylene radical having 2 to 15 carbon atoms,
Z is H or —CH₂—Y, and
Y is H or an alkyl, cycloalkyl, aralkyl or aryl radical having 1 to 11 carbon atoms,
wherein the two nitrogen atoms to which the A radical is attached are separated from one another by at least two carbon atoms and the amine of the formula (I) contains a total of at least 8 carbon atoms,
with at least one novolak epoxy resin having an average functionality in the range from 2.5 to 4.

The “average functionality” of an epoxy resin refers to the average value of the number of epoxy groups per molecule.

“Liquid epoxy resin” refers to an industrial polyepoxide having a glass transition temperature below 25° C.

Substance names beginning with “poly”, such as polyamine or polyepoxide, refer to substances that formally contain two or more of the functional groups that occur in their name per molecule.

A “primary amino group” refers to an amino group that is attached to a single organic radical and bears two hydrogen atoms; a “secondary amino group” refers to an amino group that is attached to two organic radicals, which may also together be part of a ring, and bears one hydrogen atom; and a “tertiary amino group” refers to an amino group that is attached to three organic radicals, two or three of which may also be part of one or more rings, and does not bear any hydrogen atoms.

“Amine hydrogen” refers to the hydrogen atoms of primary and secondary amino groups.

“Amine hydrogen equivalent weight” refers to the mass of an amine or an amine-containing composition that contains one molar equivalent of amine hydrogen. It is expressed in units of “g/eq”.

The “epoxide equivalent weight” refers to the mass of an epoxy group-containing compound or composition that contains one molar equivalent of epoxy groups. It is expressed in units of “g/eq”.

A “thinner” refers to a substance that is soluble in an epoxy resin and lowers its viscosity and that is not chemically incorporated into the epoxy resin polymer during the curing process.

“Molecular weight” refers to the molar mass (in grams per mole) of a molecule. “Average molecular weight” refers to the number-average Mₙ of a polydisperse mixture of oligomeric or polymeric molecules, which is normally determined by gel-permeation chromatography (GPC) against polystyrene as standard.

The “gel time” is the time interval from mixing the components of an epoxy resin composition until the gelation thereof.

A dashed line in the formulas in each case represents the bond between a substituent and the corresponding molecular radical.

“Room temperature” refers to a temperature of 23° C.

All industry standards and norms mentioned in this document relate to the versions valid at the date of first filing.

Percentages by weight (% by weight), abbreviated to wt %, refer to proportions by mass of a constituent of a composition or a molecule, based on the overall composition or the overall molecule, unless otherwise stated. The terms “mass” and “weight” are used synonymously in the present document.

In the amine of the formula (I), A is selected preferably from the group consisting of 1,2-ethylene, 1,2-propylene, 1,3-propylene, 1,4-butylene, 1,3-butylene, 2-methyl-1,2-propylene, 1,3-pentylene, 1,5-pentylene, 2,2-dimethyl-1,3-propylene, 1,6-hexylene, 2-methyl-1,5-pentylene, 1,7-heptylene, 1,8-octylene, 2,5-dimethyl-1,6-hexylene, 1,2-cyclohexylene, 1,3-cyclohexylene, 1,4-cyclohexylene, 4(2)-methyl-1,3-cyclohexylene, 1,3-cyclohexylenebis(methylene), and 1,4-cyclohexylenebis(methylene).

Preference among these is given to 1,2-ethylene or 1,2-propylene.

A is more preferably 1,2-ethylene. These amines of the formula (I) permit low-viscosity adducts having particularly rapid curing.

In the amine of the formula (I), Y is selected preferably from the group consisting of H, methyl, ethyl, propyl, isopropyl, butyl, pentyl, heptyl, hept-2-yl, phenyl, 4-methylphenyl, 1-naphthyl, and cyclohexyl.

More preferably, Y is phenyl or cyclohexyl, especially phenyl. Such an amine of the formula (I) permits low-viscosity adducts having particularly rapid and unproblematic curing.

In the amine of the formula (I) Z is preferably H, or the amine of the formula (I) is a mixture comprising amine of the formula (I) where Z═H and amine of the formula (I) where Z═—CH₂—Y. Y in the two amines is preferably the same radical.

A mixture comprising amine of the formula (I) where Z═H and amine of the formula (I) where Z═—CH₂—Y preferably comprises not more than 35% by weight, preferably not more than 30% by weight, of amine of the formula (I) where Z═—CH₂—Y, based on the sum total of the two amines.

More preferably, Z is H. In particular, in such an amine of the formula (I) the content of amine of the formula (I) where Z═—CH₂—Y is less than 5% by weight. Such an adduct permits particularly rapid curing.

The amine of the formula (I) is selected preferably from the group consisting of N-benzylethane-1,2-diamine, N,N′-dibenzylethane-1,2-diamine, N-(4-methylbenzyl)ethane-1,2-diamine, N,N′-bis(4-methylbenzyl)ethane-1,2-diamine, N-(1-naphthylmethyl)ethane-1,2-diamine, N,N′-bis(1-naphthylmethyl)ethane-1,2-diamine, N-cyclohexylmethylethane-1,2-diamine, N,N′-dicyclohexylmethylethane-1,2-diamine, N-benzylpropane-1,2-diamine, and N,N′-dibenzylpropane-1,2-diamine.

Most preferably, A is 1,2-ethylene and Y is phenyl. Such an amine of the formula (I) permits adducts having particularly low viscosity and particularly rapid and unproblematic curing.

The amine of the formula (I) is particularly preferably N-benzylethane-1,2-diamine.

The amine of the formula (I) is further preferably a mixture of N-benzylethane-1,2-diamine and N,N′-dibenzylethane-1,2-diamine in a weight ratio in the range from 65/35 to 95/5, preferably 70/30 to 90/10.

The amine of the formula (I) is preferably prepared by partial alkylation of at least one amine of formula H₂N-A-NH₂ with at least one alkylating agent. The alkylation is preferably a reductive alkylation using an aldehyde of the formula Y—CH═O as alkylating agent and hydrogen. Particularly preferably, a molar excess of amine of formula H₂N-A-NH₂ is reductively alkylated with an aldehyde of formula Y—CH═O, the excess amine of formula H₂N-A-NH₂ being removed from the reaction product by distillation. This preparation is particularly preferred in the case of small radicals A such as 1,2-ethylene.

The amine of the formula (I) where Z═H can then be freed of the corresponding dialkylated amine of the formula (I) where Z═—CH₂—Y by distillation.

The amine of the formula (I) preferably has only a low content of dialkylated amine of the formula (I) where Z═—CH₂—Y, especially not more than 35% by weight, preferably not more than 30% by weight, based on the sum total of the two amines.

More preferably, the amine of the formula (I) where Z═H contains less than 5% by weight of the corresponding dialkylated amine of the formula (I) where Z═—CH₂—Y. Such an adduct permits particularly rapid curing.

The novolak epoxy resin is preferably liquid at room temperature.

The novolak epoxy resin preferably has an average functionality in the range from 2.7 to 3.7.

The novolak epoxy resin is preferably a phenol-formaldehyde novolak glycidyl ether. In particular, it has the formula (II),

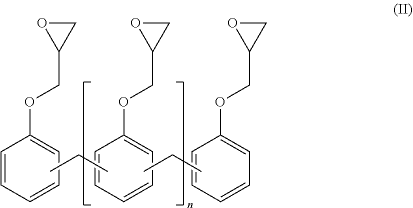

where n on average has a value in the range from 0.5 to 2, preferably 0.7 to 1.7.

The novolak epoxy resin preferably has an average epoxy equivalent weight in the range from 165 to 210 g/eq. especially 170 to 185 g/eq.

Especially suitable as the novolak epoxy resin are commercially available industrial phenol-formaldehyde novolak glycidyl ethers, such as in particular Epilox® N 18-10 (from Leuna Harze), D.E.N. 431, D.E.N. 438 or D.E.N. 439 (all from Olin), Araldite® EPN 1179 or Araldite® EPN 1180 (all from Huntsman), Epalloy® 8250, Epalloy® 8330 or Epalloy® 8350 (all from Huntsman), or Epon® Resin 154 or Epon® Resin 160 (from Momentive).

The reaction between the amine of the formula (I) and the novolak epoxy resin preferably takes place in a stoichiometric ratio of less than 3 mol, preferably less than 2.6 mol, of amine of the formula (I) to 1 molar equivalent of epoxy groups, especially in the range from 1.3 to 2.5 mol, preferably 1.4 to 2.1 mol, of amine of the formula (I) to 1 molar equivalent of epoxy groups.

Such an adduct contains particularly little unreacted amine of the formula (I) and a high content of adduct molecules. It has particularly low odor and surprisingly low viscosity. It permits particularly rapid curing and a particularly high level of flexibility for combining with further amines.

In the case of a novolak epoxy resin having a high functionality in the range from 3 to 4, the stoichiometric ratio in the reaction is preferably in the range from 1.6 to 2.5 mol, especially 1.8 to 2.1 mol, of amine of the formula (I) to 1 molar equivalent of epoxy groups.

The temperature during the reaction is preferably in the range from 40 to 120° C., especially 60 to 100° C.

The amine of the formula (I) is preferably initially charged and especially heated to a temperature in the range from 40 to 100° C. before the novolak epoxy resin is metered in and incorporated. The novolak epoxy resin is preferably metered in at a temperature in the range from 20 to 100° C., especially 50 to 100° C. The addition preferably takes place at such a rate that the reaction mixture does not exceed a temperature of 120° C., preferably 100° C.

After the reaction, unreacted amine of the formula (I) is preferably not removed from the adduct but remains therein and is a constituent of the adduct.

The adduct obtained is stored with the exclusion of moisture. It has low odor, is liquid at room temperature, and has surprisingly low viscosity, making it very easy to handle.

The adduct especially contains oligomeric compounds of the formula (III),

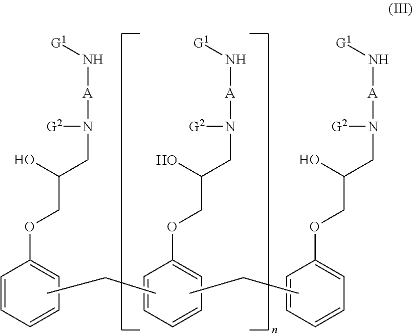

where
n on average has a value in the range from 0.5 to 2, preferably 0.7 to 1.7, G¹ and G² are Z, with the proviso that at least one of the two is —CH₂—Y, and Y and A are as previously defined.

In addition, the adduct contains fractions that are more highly adducted in which more than one amine hydrogen of one or more amines of the formula (I) has reacted.

The adduct preferably contains less than 10% by weight, preferably less than 5% by weight, especially less than 1% by weight, of thinners.

The adduct preferably contains less than 1% by weight of water.

The adduct preferably has a viscosity at 20° C. in the range from 5 to 500 Pa·s, preferably 10 to 350 Pa·s, measured using a cone-plate viscometer at a shear rate of 10 s₋₁.

The adduct of the invention is particularly suitable for curing an epoxy resin.

The invention further provides a curing agent for epoxy resins, comprising the adduct of the invention and at least one further constituent selected from the group consisting of further amines, accelerators, and thinners.

The curing agent preferably contains 10% to 80% by weight, preferably 15% to 70% by weight, especially 20% to 60% by weight, of the adduct of the invention.

The curing agent for epoxy resins is preferably not water-based. It especially contains less than 15% by weight, preferably less than 10% by weight, of water. Such a curing agent is suitable for nonaqueous epoxy resin products.

The curing agent preferably contains at least one further amine that has aliphatic amino groups and at least three amine hydrogens and was not present during the preparation of the adduct. This further amine may be the same amine of the formula (I) as the one used to prepare the adduct, or it may be a different amine.

Especially suitable as the further amine is N-benzylethane-1,2-diamine, N-benzylpropane-1,2-diamine, N-benzyl-1,3-bis(aminomethyl)benzene, N-(2-ethylhexyl)-1,3-bis(aminomethyl)benzene, 2,2-dimethylpropane-1,3-diamine, pentane-1,3-diamine (DAMP), pentane-1,5-diamine, 1,5-diamino-2-methylpentane (MPMD), 2-butyl-2-ethylpentane-1,5-diamine (C11-neodiamine), hexane-1,6-diamine, 2,5-dimethylhexane-1,6-diamine, 2,2(4), 4-trimethylhexane-1,6-diamine (TMD), heptane-1,7-diamine, octane-1,8-diamine, nonane-1,9-diamine, decane-1,10-diamine, undecane-1,11-diamine, dodecane-1,12-diamine, 1,2-, 1,3- or 1,4-diaminocyclohexane, 1,3-bis(aminomethyl)cyclohexane, 1,4-bis(aminomethyl)cyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane, 1-amino-3-aminomethyl-3,5,5-trimethylcyclohexane (IPDA), 2(4)-methyl-1,3-diaminocyclohexane, 2,5(2,6)-bis(aminomethyl)bicyclo[2.2.1]heptane (NBDA), 3(4), 8(9)-bis(aminomethyl)tricyclo[5.2.1.0^{2.6}]decane, 1,4-diamino-2,2,6-trimethylcyclohexane (TMCDA), menthane-1,8-diamine, 3,9-bis(3-aminopropyl)-2,4,8,10-tetraoxaspiro[5.5]undecane, 1,3-bis(aminomethyl)benzene (MXDA), 1,4-bis(aminomethyl)benzene, bis(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine or higher oligomers of these diamines, bis(3-aminopropyl)polytetrahydrofurans or other polytetrahydrofurandiamines, polyoxyalkylenediamines or -triamines, especially polyoxypropylenediamines or polyoxypropylenetriamines such as Jeffamine® D-230, Jeffamine® D-400 or Jeffamine® T-403 (all from Huntsman), diethylenetriamine (DETA), triethylenetetramine (TETA), tetraethylenepentamine (TEPA), pentaethylenehexamine (PEHA), dipropylenetriamine (DPTA), N-(2-aminoethyl)propane-1,3-diamine (N3-amine), N,N′-bis(3-aminopropyl)ethylenediamine (N4-amine), N,N′-bis(3-aminopropyl)-1,4-diaminobutane, N5-(3-aminopropyl)-2-methylpentane-1,5-diamine, N3-(3-aminopentyl)pentane-1,3-diamine, N5-(3-amino-1-ethylpropyl)-2-methylpentane-1,5-diamine, N,N′-bis(3-amino-1-ethylpropyl)-2-methylpentane-1,5-diamine, 3-(2-aminoethyl)aminopropylamine, bis(hexamethylene)triamine (BHMT), N-aminoethylpiperazine, 3-dimethylaminopropylamine (DMAPA) or 3-(3-(dimethylamino)propylamino)propylamine (DMAPAPA), amine-functional adducts of the amines mentioned with epoxides or a mixture of two or more of these amines.

The curing agent particularly preferably comprises at least one further amine selected from the group consisting of N-benzylethane-1,2-diamine, N,N′-dibenzylethane-1,2-diamine, MPMD, TMD, 1,2-diaminocyclohexane, 1,3-bis(aminomethyl)cyclohexane, 1,4-bis(aminomethyl)cyclohexane, bis(4-aminocyclohexyl)methane, IPDA, 2(4)-methyl-1,3-diaminocyclohexane, MXDA, DETA, TETA, TEPA, N3-amine, N4-amine, DPTA, BHMT, polyoxypropylene diamines having an average molecular weight Mₙ in the range from 200 to 500 g/mol, and polyoxypropylene triamines having an average molecular weight Mₙ in the range from 300 to 500 g/mol.

Preference among these is given to 1,3-bis(aminomethyl)cyclohexane or 1,4-bis(aminomethyl)cyclohexane, especially 1,3-bis(aminomethyl)cyclohexane. These permit particularly rapid curing.

Preference among these is also given to IPDA. This achieves particularly high glass transition temperatures, which permits particularly good robustness to high use temperatures.

Preference among these is also given to MXDA. This achieves high curing rates and particularly high strengths, and particularly high thermal shock resistance in particular.

Preference among these is also given to N-benzylethane-1,2-diamine. This affords particularly low-viscosity epoxy resin products having particularly nice surfaces.

The curing agent preferably contains an amount of further amines such that 5 to 70%, preferably 7 to 55%, especially 10 to 40%, of all amine hydrogens present originate from the adduct according to the invention.

Suitable accelerators are especially acids or compounds hydrolyzable to acids, especially organic carboxylic acids such as acetic acid, benzoic acid, salicylic acid, 2-nitrobenzoic acid, lactic acid, organic sulfonic acids such as methanesulfonic acid, p-toluenesulfonic acid or 4-dodecylbenzenesulfonic acid, sulfonic esters, other organic or inorganic acids, such as phosphoric acid in particular, or mixtures of the abovementioned acids and acid esters; nitrates such as calcium nitrate in particular; tertiary amines such as in particular 1,4-diazabicyclo[2.2.2]octane, benzyldimethylamine, α-methylbenzyldimethylamine, triethanolamine, dimethylaminopropylamine, imidazoles such as in particular N-methylimidazole, N-vinylimidazole or 1,2-dimethylimidazole, salts of such tertiary amines, quaternary ammonium salts, such as benzyltrimethylammonium chloride in particular, amidines, such as 1,8-diazabicyclo[5.4.0]undec-7-ene in particular, guanidines, such as 1,1,3,3-tetramethylguanidine in particular, phenols, especially bisphenols, phenolic resins or Mannich bases such as in particular 2-(dimethylaminomethyl)phenol, 2,4,6-tris(dimethylaminomethyl)phenol or polymers produced from phenol, formaldehyde and N,N-dimethylpropane-1,3-diamine, phosphites such as in particular di- or triphenyl phosphites, or compounds having mercapto groups.

Preference is given to acids, nitrates, tertiary amines or Mannich bases, especially salicylic acid, calcium nitrate or 2,4,6-tris(dimethylaminomethyl)phenol, or a combination of these accelerators.

Suitable thinners are especially n-propanol, isopropanol, n-butanol, isobutanol, tert-butanol, 1-pentanol, 2-pentanol, 3-pentanol, 2-methyl-1-butanol, 3-methyl-1-butanol, 3-methyl-2-butanol, n-hexanol, 2-ethylhexanol, xylene, 2-methoxyethanol, dimethoxyethanol, 2-ethoxyethanol, 2-propoxyethanol, 2-isopropoxyethanol, 2-butoxyethanol, 2-phenoxyethanol, 2-benzyloxyethanol, benzyl alcohol, ethylene glycol, ethylene glycol dimethyl ether, ethylene glycol diethyl ether, ethylene glycol dibutyl ether, ethylene glycol diphenyl ether, diethylene glycol, diethylene glycol monomethyl ether, diethylene glycol monoethyl ether, diethylene glycol mono-n-butyl ether, diethylene glycol dimethyl ether, diethylene glycol diethyl ether, diethylene glycol di-n-butyl ether, propylene glycol butyl ether, propylene glycol phenyl ether, dipropylene glycol, dipropylene glycol monomethyl ether, dipropylene glycol dimethyl ether, dipropylene glycol di-n-butyl ether, 2,2,4-trimethylpentane-1,3-diol monoisobutyrate, diphenylmethane, diisopropylnaphthalene, mineral oil fractions, for example Solvesso® grades (from Exxon), alkylphenols such as tert-butylphenol, nonylphenol, dodecylphenol, cardanol, styrenated phenol, bisphenols, aromatic hydrocarbon resins, especially types containing phenol groups, alkoxylated phenol, especially ethoxylated or propoxylated phenol, especially 2-phenoxyethanol, adipates, sebacates, phthalates, benzoates, organic phosphoric or sulfonic esters or sulfonamides.

Preference among these is given to thinners having a boiling point of more than 200° C., especially benzyl alcohol, styrenated phenol, ethoxylated phenol, aromatic hydrocarbon resins containing phenol groups, such as in particular the Novares® grades LS 500, LX 200, LA 300 or LA 700 (from Rüitgers), diisopropylnaphthalene or cardanol, especially benzyl alcohol.

Thinners containing phenol groups are effective also as accelerators.

Preference among these is also given to low-toxicity, low-odor thinners having a boiling point in the range from 90 to 150° C., especially n-butanol, 1-pentanol, 3-pentanol, 3-methyl-1-butanol or 3-methyl-2-butanol. Such thinners permit low-odor, readily workable anti-corrosion coatings in which the thinner has evaporated in a relatively short time, giving it little opportunity to penetrate and damage any insulation applied over the anti-corrosion coating.

Preference among these is given also to aromatic thinners having a particularly high thinning effect, especially xylene.

The curing agent may comprise further constituents, especially the following:
further adducts, especially adducts of MPMD or ethane-1,2-diamine or propane-1,2-diamine with cresyl glycidyl ether, in which unreacted MPMD, ethane-1,2-diamine or propane-1,2-diamine have been removed by distillation after the reaction;
monoamines such as in particular benzylamine or furfurylamine;
polyamidoamines, especially reaction products of a mono- or polybasic carboxylic acid, or the ester or anhydride thereof, especially a dimer fatty acid, with a polyamine used in stoichiometric excess, especially DETA or TETA;
Mannich bases, especially phenalkamines, i.e. reaction products of phenols, especially cardanol, with aldehydes, especially formaldehyde, and polyamines.
aromatic polyamines such as in particular 4,4′-, 2,4′- and/or 2,2′-diaminodiphenylmethane, 2,4(6)-toluenediamine, 3,5-dimethylthio-2,4(6)-toluenediamine or 3,5-diethyl-2,4(6)-tolylenediamine;
compounds having mercapto groups, especially liquid mercaptan-terminated polysulfide polymers, mercaptan-terminated polyoxyalkylene ethers, mercaptan-terminated polyoxyalkylene derivatives, polyesters of thiocarboxylic acids, 2,4,6-trimercapto-1,3,5-triazine, triethylene glycol dimercaptan or ethanedithiol.

The present invention further provides an epoxy resin composition comprising
a resin component comprising at least one epoxy resin and
a curing agent component comprising at least one adduct according to the invention or the curing agent described above.

The curing agent component preferably comprises the curing agent described above.

A suitable epoxy resin is obtained in a known manner especially from the reaction of epichlorohydrin with polyols, polyphenols or amines.

Suitable epoxy resins are especially aromatic epoxy resins, especially the glycidyl ethers of:
bisphenol A, bisphenol F or bisphenol A/F, where A stands for acetone and F for formaldehyde used as reactants in the production of these bisphenols. In the case of bisphenol F, positional isomers may also be present, more particularly ones derived from 2,4′- or 2,2′-hydroxyphenylmethane.
dihydroxybenzene derivatives such as resorcinol, hydroquinone or catechol;
further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether or bis(4-hydroxyphenyl) sulfone;
novolaks, which are especially condensation products of phenol or cresols with formaldehyde or paraformaldehyde or acetaldehyde or crotonaldehyde or isobutyraldehyde or 2-ethylhexanal or benzaldehyde or furfural;
aromatic amines such as aniline, toluidine, 4-aminophenol, 4,4′-methylenediphenyldiamine, 4,4′-methylenediphenyldi(N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

Further suitable epoxy resins are aliphatic or cycloaliphatic polyepoxides, especially
glycidyl ethers of saturated or unsaturated, branched or unbranched, cyclic or open-chain di-, tri- or tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol A, F or A/F liquid resin or the glycidylation products of hydrogenated bisphenol A, F or A/F;
an N-glycidyl derivative of amides or heterocyclic nitrogen bases, such as triglycidyl cyanurate or triglycidyl isocyanurate, or reaction products of epichlorohydrin with hydantoin.

The epoxy resin is preferably a liquid resin or a mixture comprising two or more liquid epoxy resins.

“Liquid epoxy resin” refers to an industrial polyepoxide having a glass transition temperature below 25° C.

The resin component optionally additionally contains proportions of solid epoxy resin.

The epoxy resin is especially a liquid resin based on a bisphenol or on novolaks, especially one having an average epoxy equivalent weight in the range from 156 to 210 g/eq.

A bisphenol A diglycidyl ether and/or bisphenol F diglycidyl ether, such as those commercially available from Olin, Huntsman or Momentive, is particularly suitable. These liquid resins have low viscosity for epoxy resins and permit rapid curing and high hardnesses. They may contain proportions of solid bisphenol A resin or novolak epoxy resins.

Also particularly suitable is a novolak epoxy resin, especially a phenol-formaldehyde novolak glycidyl ether, especially having an average functionality in the range from 2.3 to 4, preferably 2.5 to 3. These afford coatings having particularly good anti-corrosion properties. They may contain proportions of other epoxy resins, especially bisphenol A diglycidyl ether or bisphenol F diglycidyl ether.

The resin component may comprise a reactive diluent.

Preferred reactive diluents are reactive diluents containing epoxy groups, especially butanediol diglycidyl ether, hexanediol diglycidyl ether, trimethylolpropane di- or triglycidyl ether, phenyl glycidyl ether, cresyl glycidyl ether, guaiacol glycidyl ether, 4-methoxyphenyl glycidyl ether, p-n-butylphenyl glycidyl ether, p-tert-butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether, or glycidyl ethers of natural alcohols, such as in particular C₈ to C₁₀ or C₁₂ to C₁₄ or C₁₃ to C₁₅ alkyl glycidyl ethers.

The epoxy resin composition preferably comprises at least one further constituent selected from the group consisting of thinners, accelerators, pigments, and fillers.

Suitable accelerators are especially those already mentioned.

Suitable thinners are especially those already mentioned.

Particularly suitable pigments are anti-corrosion pigments, titanium dioxides, iron oxides, chromium(III) oxides, organic pigments or carbon black, especially anti-corrosion pigments and/or titanium dioxides.

Suitable anti-corrosion pigments are especially phosphorus-containing anti-corrosion pigments, especially phosphates, orthophosphates or polyphosphates that contain as counterion especially chromium, zinc, aluminum, calcium, strontium or a combination of these metals. A zinc orthophosphate, zinc aluminum orthophosphate, calcium phosphate, zinc polyphosphate, zinc aluminum polyphosphate or strontium aluminum polyphosphate is particularly suitable, especially an organically modified basic zinc orthophosphate hydrate.

Suitable fillers are, in particular, ground or precipitated calcium carbonate, which is optionally coated with fatty acid, especially stearates, baryte (heavy spar), talc, quartz powder, quartz sand, silicon carbide, iron mica, dolomite, wollastonite, kaolin, mica (potassium aluminum silicate), molecular sieves, aluminum oxide, zinc oxide, aluminum-doped zinc oxide, aluminum hydroxide, magnesium hydroxide, silica, cement, gypsum, fly ash, carbon black, graphite, metal powders such as aluminum, copper, iron, zinc, silver or steel, PVC powder or hollow beads.

Preference among these is given to calcium carbonate, baryte, quartz powder, talc, aluminum powder or a combination thereof.

The epoxy resin composition may optionally comprise further auxiliaries and additives, especially the following:
reactive diluents, especially those already mentioned, or epoxidized soybean oil or linseed oil, compounds containing acetoacetate groups, especially acetoacetylated polyols, butyrolactone, carbonates, aldehydes, isocyanates or silicones having reactive groups;
polymers, especially polyamides, polysulfides, polyvinyl formal (PVF), polyvinyl butyral (PVB), polyurethanes (PUR), polymers having carboxyl groups, polyamides, butadiene-acrylonitrile copolymers, styrene-acrylonitrile copolymers, butadiene-styrene copolymers, homo- or copolymers of unsaturated monomers, especially from the group comprising ethylene, propylene, butylene, isobutylene, isoprene, vinyl acetate or alkyl (meth)acrylates, especially chlorosulfonated polyethylenes or fluorine-containing polymers or sulfonamide-modified melamines;
fibers, especially glass fibers, carbon fibers, metal fibers, ceramic fibers or polymer fibers such as polyamide fibers or polyethylene fibers;
nanofillers, especially carbon nanotubes;
rheology modifiers, especially thickeners or antisettling agents;
adhesion improvers, especially organoalkoxysilanes;
flame-retardant substances, especially the aluminum hydroxide or magnesium hydroxide fillers already mentioned, antimony trioxide, antimony pentoxide, boric acid (B(OH)₃), zinc borate, zinc phosphate, melamine borate, melamine cyanurate, ammonium polyphosphate, melamine phosphate, melamine pyrophosphate, polybrominated diphenyl oxides or diphenyl ethers, phosphates such as in particular diphenyl cresyl phosphate, resorcinol bis(diphenyl phosphate), resorcinol diphosphate oligomer, tetraphenylresorcinol diphosphite, ethylenediamine diphosphate, bisphenol A bis(diphenyl phosphate), tris(chloroethyl) phosphate, tris(chloropropyl) phosphate, tris(dichloroisopropyl) phosphate, tris[3-bromo-2,2-bis(bromomethyl)propyl] phosphate, tetrabromobisphenol A, bis(2,3-dibromopropyl ether) of bisphenol A, brominated epoxy resins, ethylenebis(tetrabromophthalimide), ethylenebis(dibromonorbornanedicarboximide), 1,2-bis(tribromophenoxy)ethane, tris(2,3-dibromopropyl) isocyanurate, tribromophenol, hexabromocyclododecane, bis(hexachlorocyclopentadieno)cyclooctane or chloroparaffins; or
additives, especially defoamers, deaerators, wetting agents, dispersants, leveling agents, dispersed paraffin wax, stabilizers against oxidation, heat, light or UV radiation, or biocides.

The epoxy resin composition preferably comprises further auxiliaries and additives, especially pigments, wetting agents, leveling agents and/or defoamers.

The epoxy resin composition preferably has only a low content of thinners. It preferably contains less than 35% by weight, more preferably less than 20% by weight, especially less than 15% by weight, of thinners.

The epoxy resin composition preferably has only a low content of water, preferably less than 5% by weight, especially less than 1% by weight, of water.

The resin component and the curing agent component of the epoxy resin composition are stored in separate containers. Further constituents of the epoxy resin composition may be present as a constituent of the resin component or of the curing agent component; further constituents reactive toward epoxy groups are preferably a constituent of the curing agent component. It is likewise possible for further constituents to be present as a separate, further component.

A suitable container for storage of the resin component or the curing agent component is especially a vat, a hobbock, a bag, a bucket, a can, a cartridge or a tube. The components are storable, meaning that they can be stored prior to use for several months up to one year or longer without any change in their respective properties to a degree relevant to their use.

The resin component and curing agent component are mixed shortly before or during application. The mixing ratio is preferably chosen such that the molar ratio of the groups reactive toward epoxy groups relative to the epoxy groups is in the range from 0.5 to 1.5, especially 0.7 to 1.2. In parts by weight, the mixing ratio between the resin component and the curing agent component is typically in the range from 1:2 to 20:1, preferably 1:1 to 20:1.

The components are mixed continuously or in batches by means of a suitable method, taking care to ensure that not too much time elapses between the mixing of the components and the application, and that application takes place within the pot life. Mixing and application are carried out especially at ambient temperature, which is typically in the range from about 5 to 40° C., preferably about 10 to 35° C.

Upon mixing the components, the curing of the epoxy resin composition by chemical reaction commences. Primary and secondary amino groups, and any further groups present that are reactive toward epoxy groups, react with the epoxy groups, resulting in ring opening thereof. As a result primarily of these reactions, the composition polymerizes and thereby cures.

Curing typically extends over a few hours to days. The duration depends on factors including the temperature, the reactivity of the constituents, the stoichiometry thereof, and the presence/amount of accelerators.

When freshly mixed, the epoxy resin composition has low viscosity. The viscosity at 20° C. 5 minutes after the resin component and curing agent component have been mixed is preferably in the range from 0.3 to 20 Pa·s, preferably 0.3 to 10 Pa·s, more preferably 0.3 to 5 Pa·s, especially 0.3 to 2 Pa·s, measured using a cone-plate viscometer at a shear rate of 10 s⁻¹.

The epoxy resin composition is applied to at least one substrate, the following substrates being particularly suitable:
glass, glass ceramic, concrete, mortar, cement screed, fiber cement, brick, tile, plaster or natural rocks such as granite or marble;
repair compounds or leveling compounds based on PCC (polymer-modified cement mortar) or ECC (epoxy resin-modified cement mortar);
metals or alloys such as aluminum, iron, steel, copper, other nonferrous metals, including surface-finished metals or alloys such as galvanized or chrome-plated metals;
asphalt or bitumen;
leather, textiles, paper, wood, wood-based materials bonded with resins, for example phenolic, melamine or epoxy resins, resin-textile composites or further so-called polymer composites;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFRP), glass fiber-reinforced plastics (GFRP), and sheet molding compounds (SMC);
insulation foams, especially made of EPS, XPS, PUR, PIR, rock wool, glass wool or foamed glass;
coated or painted substrates, especially painted tiles, coated concrete, powder-coated metals or alloys or painted metal sheets;
coatings, paints or varnishes, especially coated floors that have been overcoated with a further floor covering layer.

The substrates can if required be pretreated prior to application, especially by physical and/or chemical cleaning methods or the application of an activator or a primer.

Particular preference as substrate is given to metals or alloys, especially steel. Such a substrate is particularly well protected against corrosion by the adduct in the epoxy resin composition.

The curing of the epoxy resin composition affords a cured composition.

The epoxy resin composition is preferably used as coating, primer, adhesive, sealant, potting compound, casting resin, impregnating resin or as matrix for fiber composites such as CFRP or GFRP in particular.

The epoxy resin composition is particularly preferably used as a coating. Coatings are understood here as meaning coverings of any kind that are applied over an area, especially floor coverings, paints, varnishes, sealants, basecoats, primers or protective coatings, especially anti-corrosion coatings for light or heavy corrosion protection.

The epoxy resin composition is particularly suitable as a floor covering or floor coating for interiors such as offices, industrial halls, sports halls or cold rooms, or outdoors for balconies, terraces, parking decks, bridges or roofs, as a protective coating for concrete, cement, metals, plastics or wood, for example for surface sealing of wood constructions, vehicles, loading areas, tanks, silos, shafts, pipelines, machines, containers or steel constructions, for example of ships, piers, offshore platforms, lock gates, hydroelectric power plants, river constructions, swimming pools, wind turbines, bridges, chimneys, cranes or sheet-pile walls, or as an undercoat, tiecoat or anticorrosion primer or for hydrophobization of surfaces.

The epoxy resin composition is very particularly suitable as an anti-corrosion coating, and as an anti-corrosion coating for insulated steel pipes or containers in particular, it being particularly suitable as a protective coating against corrosion under insulation (abbreviated CUI). The epoxy resin composition of the invention has been shown here to have a high thermal shock resistance according to DIN EN ISO 19277. A layer having a thickness of 250 μm on steel withstands multiple shock-like temperature changes between ice-water and 200° C. without cracking.

For use as a coating, the epoxy resin composition preferably has particularly low viscosity and good leveling properties. The mixed composition is typically applied, within its pot life, to the surface of a substrate as a thin film having a layer thickness of about 50 μm to about 5 mm, typically at ambient temperature. It is applied especially by pouring onto the substrate to be coated and then spreading it evenly using for example a doctor blade or a notched trowel, or by means of a brush or roller or a spraying process. Curing typically gives rise to substantially homogeneous, glossy and nontacky films of high hardness that have good adhesion to a wide variety of different substrates.

In this case, the epoxy resin composition is used in particular in a method for coating, comprising the steps of
(i) applying the mixed epoxy resin composition to a substrate within the pot life, followed by curing of the composition,
(ii) optionally applying a further layer of the mixed epoxy resin composition to the cured layer within the pot life,
(iii) optionally repeating step (ii), and
(iv) optionally applying a further composition to the cured layer; this can be another epoxy resin composition or else it can be a different material, especially a polyurethane or polyurea coating.

Where the epoxy resin composition is used in the form of a multilayer coating, it has particularly good intercoat adhesion.

Particular preference is also given to using the epoxy resin composition as an adhesive. When used as adhesive, the epoxy resin composition typically has, after the components have been mixed, a pasty consistency with structurally viscous properties. On application, the mixed adhesive is applied within the pot life to at least one of the substrates to be bonded and the two substrates are joined to form an adhesive bond within the open time of the adhesive.

The mixed adhesive is applied especially by means of a brush, roll, spatula, doctor blade or trowel, or from a tube, cartridge or metering device.

The adhesive is particularly suitable for uses in the construction industry, especially for the reinforcement of built structures by means of steel lamellas or lamellas made of carbon fiber-reinforced composite plastics (CFRP), for constructions containing bonded precast concrete components, especially bridges or concrete towers, for example for wind turbines, shafts, pipelines or tunnels, or for constructions containing bonded natural rocks, ceramic elements or parts made of fiber cement, steel, cast iron, aluminum, wood or polyester, for the anchoring of dowels or steel bars in boreholes, for the fixing of, for example, handrails, balustrades or door frames, for repairs such as in particular the filling of edges, holes or joins in concrete maintenance, or for the bonding of films of polyvinyl chloride (PVC), flexibilized polyolefin (Combiflex®) or adhesion-modified chlorosulfonated polyethylene (Hypalon®) to concrete or steel.

Further fields of use relate to structural bonding in the construction or manufacturing industry, especially as adhesive mortar, assembly adhesive, reinforcement adhesive such as in particular for the bonding of lamellas made of CFRP or steel to concrete, brickwork or wood, as element adhesive, for example for bridge elements, sandwich element adhesive, facade element adhesive, reinforcing adhesive, bodywork adhesive or half-shell adhesive for rotor blades of wind turbines.

In these applications, the epoxy resin composition is used in particular in a method for bonding, comprising the steps of
(i) mixing the components of the epoxy resin composition,
(ii) applying the mixed composition within the pot life,
   either to at least one of the substrates to be bonded and joining the substrates to form a bond within the open time,
   or into a cavity or gap between two or more substrates and optionally inserting an anchor into the cavity or gap within the open time, followed by curing of the mixed composition.

An “anchor” refers here more particularly to a rebar, a threaded rod or a bolt. An anchor is in particular thus adhesive-bonded or anchored in a wall, ceiling or foundation in such a way that a portion thereof is bonded in a force-fitting manner and a portion thereof protrudes and can be subjected to a construction load.

Identical or different substrates may be bonded.

The application and curing of the epoxy resin composition afford an article.

The invention thus further provides an article obtained from the use of the epoxy resin composition.

The article is preferably a built structure or a part thereof, especially a built structure above or below ground, an office, an industrial hall, a sports hall, a cold room, a silo, a bridge, a roof, a staircase, a floor, a balcony, a terrace or a parking deck, or an industrial good or a consumer good, especially a pier, an offshore platform, a lock gate, a crane, a bulkhead, a pipeline, an insulated container or a rotor blade of a wind turbine, or a mode of transport such as in particular an automobile, a truck, a rail vehicle, a ship, an aircraft or helicopter, or an installable component thereof.

The epoxy resin composition of the invention is readily workable at ambient temperatures and cures surprisingly quickly, forming even, defect-free surfaces with a low tendency to yellowing. It is especially suitable as an esthetically high-quality anti-corrosion coating that is robust to moisture, even in combination with heat and/or salts, and has particularly good thermal shock resistance and intercoat adhesion.

### EXAMPLES

Working examples are presented hereinbelow, the purpose of which is to further elucidate the described invention. The invention is of course not limited to these described working examples.

“AHEW” stands for amine hydrogen equivalent weight.

“EEW” stands for epoxy equivalent weight.

“Standard climatic conditions” (“SCC”) refer to a temperature of 23±10° C. and a relative humidity of 50±5%.

The chemicals used were unless otherwise stated from Sigma-Aldrich Chemie GmbH.

Description of the Measurement Methods:

Viscosity was measured on a thermostated Rheotec RC30 cone-plate viscometer (cone diameter 50 mm, cone angle 1°, cone tip-plate distance 0.05 mm, shear rate 10 s⁻¹).

Amine value was determined by titration (with 0.1 N HClO₄ in acetic acid against crystal violet).

Substances and Abbreviations Used:
D.E.N.® 431: Phenol-formaldehyde novolak glycidyl ether, EEW approx. 175 g/eq, average functionality approx. 2.8 (from Olin)
D.E.N.® 438: Phenol-formaldehyde novolak glycidyl ether, EEW approx. 180 g/eq, average functionality approx. 3.6 (from Olin)
Epilox® N 18-10 Phenol-formaldehyde novolak glycidyl ether, EEW approx. 175 g/eq, average functionality approx. 2.6 (from Leuna Harze)
Araldite® GY 250: Bisphenol A diglycidyl ether, EEW approx. 187 g/eq (from Huntsman)
Araldite® DY-E: Monoglycidyl ethers of C₁₂ to C₁₄ alcohols, EEW approx. 290 g/eq (from Huntsman)
B-EDA N-Benzylethane-1,2-diamine, prepared as described below, 150.2 g/mol, AHEW 50.1 g/eq
IPDA 3-Aminomethyl-3,5,5-trimethylcyclohexylamine, AHEW 42.6 g/eq (Vestamin® IPD from Evonik)

### N-Benzylethane-1,2-diamine (B-EDA)

An initial charge of 180.3 g (3 mol) of ethane-1,2-diamine at room temperature was mixed with a solution of 106.0 g (1 mol) of benzaldehyde in 1200 ml of isopropanol and stirred for 2 hours, then hydrogenated at 80° C., 80 bar hydrogen pressure, and a flow rate of 5 ml/min in a continuous hydrogenation apparatus with a Pd/C fixed-bed catalyst, and the hydrogenated solution was concentrated on a rotary evaporator at 65° C., resulting in the removal of unreacted ethane-1,2-diamine, water, and isopropanol. The resulting reaction mixture was purified by distillation at 80° C. under reduced pressure. This gave a colorless liquid having an N-benzylethane-1,2-diamine content determined by GC of >97%.

Preparation of Adducts:

Adduct A1:

55.0 g of N-benzylethane-1,2-diamine (B-EDA, 0.366 mol) were heated to 80° C. and 33.0 g of D.E.N.® 438 (0.183 mol EP groups) heated to a temperature of 60° C. were added gradually with thorough stirring, maintaining the temperature of the reaction mixture between 70 and 90° C. The reaction mixture was held within this temperature range for one hour and then cooled. A clear, slightly yellowish liquid having a viscosity at 20° C. of 24.1 Pa·s, an amine value of 460 mg KOH/g, and a calculated AHEW of 96.2 g/eq was obtained.

Adduct A2:

55.0 g of N-benzylethane-1,2-diamine (B-EDA, 0.366 mol) was heated to 80° C. and 32.0 g of D.E.N.® 431 (0.183 mol EP groups) heated to a temperature of 60° C. was added gradually with thorough stirring, maintaining the temperature of the reaction mixture between 70 and 90° C. The reaction mixture was held within this temperature range for one hour and then cooled. A clear, slightly yellowish liquid having a viscosity at 20° C. of 8.4 Pa·s, an amine value of 464 mg KOH/g, and a calculated AHEW of 95.1 g/eq was obtained.

Adduct A3:

55.0 g of N-benzylethane-1,2-diamine (B-EDA, 0.366 mol) were heated to 80° C. and 42.7 g of D.E.N.® 431 (0.244 mol EP groups) heated to a temperature of 60° C. were added gradually with thorough stirring, maintaining the temperature of the reaction mixture between 70 and 90° C. The reaction mixture was held within this temperature range for one hour and then cooled. A clear, slightly yellowish liquid having a viscosity at 20° C. of 256 Pa·s, an amine value of 404 mg KOH/g, and a calculated AHEW of 114.4 g/eq was obtained.

Adduct A4 (Ref.):

55.0 g of N-benzylethane-1,2-diamine (B-EDA, 0.366 mol) were heated to 80° C. and 45.0 g of Araldite® GY 250 (0.241 mol EP groups) were added gradually with thorough stirring, maintaining the temperature of the reaction mixture between 70 and 90° C. The reaction mixture was held within this temperature range for one hour and then cooled. A clear, slightly yellowish liquid having a viscosity at 20° C. of 262 Pa·s, an amine value of 408 mg KOH/g, and a calculated AHEW of 116.3 g/eq was obtained.

Adduct A5 (Ref.):

An initial charge of 47.7 g of 1,2-diaminocyclohexane (Dytek® DCH-99, from Invista, 0.42 mol) was heated to 60° C. To this were slowly added with thorough stirring 37.6 g of D.E.N.® 438 (0.21 mol EP groups) preheated to 60° C., maintaining the temperature of the reaction mixture between 70 and 90° C. The reaction mixture was held within this temperature range for one hour and then cooled. A clear, slightly yellowish, highly viscous liquid having a viscosity at 50° C. of 98 Pa·s, an amine value of 532 mg KOH/g, and a calculated AHEW of 58.3 g/eq was obtained.

Adduct A6 (Ref.):

An initial charge of 90.0 g of bis(6-aminohexyl)amine (Dytek® BHMT-HP, from Invista, 0.42 mol) was heated to 60° C. To this was slowly added with thorough stirring 37.6 g of DEN® 438 (0.21 mol EP groups) preheated to 60° C., maintaining the temperature of the reaction mixture between 70 and 90° C. The reaction mixture was held within this temperature range for one hour and then cooled. A clear, slightly yellowish liquid having a viscosity at 20° C. of 22.5 Pa·s, an amine value of 529 mg KOH/g, and a calculated AHEW of 67.9 g/eq was obtained.

Production of Epoxy Resin Coatings:

### Examples 1 to 11

For each example, the ingredients of the resin component specified in Tables 1 and 2 were mixed in the specified amounts (in parts by weight) using a centrifugal mixer (SpeedMixer™ DAC 150, FlackTek Inc.) and stored with the exclusion of moisture.

The ingredients of the curing agent component specified in Tables 1 and 2 were likewise processed and stored.

The two components of each composition were then processed using the centrifugal mixer into a homogeneous liquid and this was tested immediately as follows:

Viscosity was measured in the described manner at a temperature of 20° C. 5 min after mixing the resin component and curing agent component.

Gel time was determined by moving a freshly mixed amount of about 3 g under standard climatic conditions with a spatula at regular intervals until the mass underwent gelation.

Shore D hardness was determined in accordance with DIN 53505 on two cylindrical test specimens (diameter 20 mm, thickness 5 mm), one of which was stored under standard climatic conditions and the other at 8° C. and 80% relative humidity, and the hardness measured in each case after 1 day and after 2 days.

Appearance (SCC) was determined on a film applied to a glass plate in a layer thickness of 500 μm and stored under standard climatic conditions for 14 days. A film was described as “nice” if it had a glossy and nontacky surface with no structure. “Structure” refers to any kind of marking or pattern on the surface.

Appearance (8°/80%) was determined on a film applied to a glass plate in a layer thickness of 500 μm and stored for 7 days at 8° C. and 80% humidity and then for 7 days under standard climatic conditions. 24 hours after application, a polypropylene bottle top beneath which a damp sponge had been positioned was placed on the film. After a further 24 hours, the sponge and the bottle top were removed and positioned at a new point on the film, from which it was in turn removed and repositioned after 24 hours, this being done a total of 4 times. The appearance of this film was then assessed in the same way as described for Appearance (SCC). “Blushing” was reported as the number of white-colored spots that had formed as a result of the damp sponge. A faint, white-colored spot was designated as “(1)”.

The König hardness (König pendulum hardness, measured in accordance with DIN EN ISO 1522) was in addition determined on some films. For this, a first film having a layer thickness of 500 μm was applied to a glass plate, stored under standard climate conditions and the König hardness determined after 1 day (“König hardness (1d SCC)”), after 2 days (“König hardness (2d SCC)”), after 7 days (“König hardness (7d SCC)”), and after 14 days (“König hardness (14d SCC)”). In addition, a second film having a layer thickness of 500 μm was applied to a glass plate and this was immediately after application stored for 7 days at 8° C. and 80% relative humidity and then for 2 weeks under standard climate conditions, with the König hardness determined after 7 days at 8° C. and 80% relative humidity (“König hardness (7d 8°/80%)”) and then after a further 2 days under SCC (“König hardness (+2d SCC)”), after a further 7 days under SCC (“König hardness (+7d SCC)”), and after a further 14 days under SCC (“König hardness (+14d SCC)”). As a measure of yellowing, the change in color after stressing in a weathering tester was additionally determined (Q-Sun (72 h)). For this, a further film in a layer thickness of 500 μm was applied to a glass plate and stored under standard climatic conditions for 14 days and then subjected to stress in a Q-Sun Xenon Xe-1 weathering tester with a Q-SUN Daylight-Q optical filter and a xenon lamp having a light intensity of 0.51 W/m² at 340 nm at a temperature of 65° C. for 72 hours. The color difference ΔE of the film thus stressed versus a corresponding unstressed film was then determined using an NH310 colorimeter from Shenzen 3NH Technology Co. LTD equipped with silicon photoelectric diode detector, light source A, color space measurement interface CIE L*a*b*C*H*.

The results are reported in Tables 1 and 2.

The examples designated “(Ref.)” are comparative examples.

TABLE 1
Composition and properties of examples 1 to 6.

| | | | | | 4 | 5 | 6 |
|---|---|---|---|---|---|---|---|
| Example | | 1 | 2 | 3 | (Ref.) | (Ref.) | (Ref.) |
| Resin component: | | | | | | | |
| Araldite ® GY 250: | | 167.2 | 167.2 | 167.2 | 167.2 | 167.2 | 167.2 |
| Araldite ® DY-E: | | 31.8 | 31.8 | 31.8 | 31.8 | 31.8 | 31.8 |
| Curing agent | | | | | | | |
| component: | | | | | | | |
| Adduct A1 | | 96.2 | — | — | — | — | — |
| Adduct A2 | | — | 95.1 | — | — | — | — |
| Adduct A3 | | — | — | 114.4 | — | — | — |
| Adduct A4 | | — | — | — | 116.3 | — | — |
| Adduct A5 | | — | — | — | — | 58.3 | — |
| Adduct A6 | | — | — | — | — | — | 67.9 |
| Viscosity (5′) [Pa · s] | | 5.9 | 4.2 | 19.4 | 15.0 | n.d.¹ | 2.0 |
| Gel time (h:min) | | 2:30 | 2:40 | 2:20 | 2:40 | n.d.¹ | 3:30 |
| Shore D | (1 d SCC) | 82 | 81 | 82 | 78 | n.m.² | 67 |
| | (2 d SCC) | 82 | 82 | 82 | 78 | 45 | 72 |
| Shore D | (1 d 8°/80%) | 74 | 74 | 74 | 74 | n.m.² | 16 |
| | (2 d 8°/80%) | 78 | 78 | 78 | 75 | n.m.² | 44 |

| | | | | | | |
|---|---|---|---|---|---|---|
| Appearance (SCC) | nice | nice | nice | nice | structure | haze |
| Appearance (8°/80%) | nice | nice | nice | nice | tacky, | haze, |
| | | | | | liquid | uneven |
| Blushing | 0 | (1) | (1) | (1) | n.m.³ | n.m.³ |
| Q-Sun (72 h) ΔE | 2.5 | 3.0 | 3.5 | 2.1 | n.d. | n.d. |

¹not determined (very high viscosity)
²not measurable (too soft)
³not measurable (surface too inhomogeneous for assessment)
“n.d.” stands for “not determined”

TABLE 2
Composition and properties of examples 7 to 11.

| | | Example | | | | |
|---|---|---|---|---|---|---|
| | | | | 9 | 10 | 11 |
| | | 7 | 8 | (Ref.) | (Ref.) | (Ref.) |
| Resin component: | | | | | | |
| Araldite ® GY 250: | | 167.2 | 167.2 | 167.2 | 167.2 | 167.2 |
| Araldite ® DY-E: | | 31.8 | 31.8 | 31.8 | 31.8 | 31.8 |
| Curing agent component: | | | | | | |
| Adduct A1 | | 38.5 | — | — | — | — |
| Adduct A3 | | — | 38.0 | — | — | — |
| Adduct A4 | | — | — | 46.5 | — | — |
| Adduct A5 | | — | — | — | 23.3 | — |
| Adduct A6 | | — | — | — | — | 27.2 |
| IPDA | | 25.8 | 25.8 | 25.8 | 25.8 | 25.8 |
| Benzyl alcohol | | 25.0 | 25.0 | 25.0 | 25.0 | 25.0 |
| Viscosity (5′) [Pa · s] | | 1.12 | 1.45 | 1.46 | 1.07 | 0.91 |
| Gel time (h:min) | | 3:25 | 3:20 | 3:30 | 4:15 | 3:20 |
| Shore D | (1 d SCC) | 66 | 67 | 65 | 68 | 68 |
| | (2 d SCC) | 78 | 78 | 78 | 78 | 76 |
| Shore D | (1 d 8°/80%) | 16 | 18 | 15 | n.m.² | 22 |
| | (2 d 8°/80%) | 65 | 67 | 63 | 39 | 65 |
| König h. | (1 d SCC) | 52 | 51 | 45 | 36 | 36 |
| [s] | (2 d SCC) | 99 | 93 | 95 | 115 | 99 |
| | (7 d SCC) | 153 | 151 | 155 | 164 | 148 |
| | (14 d SCC) | 161 | 158 | 160 | 176 | 151 |
| König h. | (7 d 8°/80%) | 31 | 38 | 22 | 28 | 18 |
| [s] | (+2 d SCC) | 115 | 122 | 115 | 87 | 52 |
| | (+7 d SCC) | 152 | 153 | 151 | 105 | 97 |
| | (+14 d SCC) | 163 | 164 | 161 | 110 | 123 |

| | | | | | |
|---|---|---|---|---|---|
| Appearance (SCC) | nice | nice | nice | nice | (structure) |
| Appearance (8°/80%) | nice | nice | nice | structure | structure |
| Blushing | (1) | (1) | (1) | 4 | 4 |
| Q-Sun (72 h) ΔE | 2.1 | 1.7 | 2.5 | n.d. | n.d. |

²not measurable (too soft);
“n.d.” stands for “not determined”

### Examples 12 to 13

For each example, the ingredients of the resin component specified in Table 3 were mixed in the specified amounts (in parts by weight) using a centrifugal mixer (SpeedMixer™ DAC 150, FlackTek Inc.) and stored with exclusion of moisture. The ingredients of the curing agent component indicated in Table 3 were processed and stored in a similar manner.

The two components of each composition were then processed using the centrifugal mixer into a homogeneous liquid and this was tested immediately as follows:
To assess the appearance and the intercoat adhesion, a test specimen of each coating was produced by spraying a wet film layer of 180 μm onto a 150×100×3 mm steel sheet using a gravity spray gun, storing this for 24 hours under standard climate conditions and then applying a second wet film layer of 180 μm using a gravity spray gun. After storage for a period of 14 days under standard climate conditions, the surface of the coating was assessed (=Appearance). An even, nontacky, glossy surface without structure, deposits or other defects was rated as “nice”. As a measure of intercoat adhesion, a pull-off adhesion test in accordance with ISO 4624 was then carried out at a test speed of 1 MPa/s, in which a dolly glued onto the coating was pulled off vertically in an upward direction. Intercoat adhesion was here rated as “poor” if the pull-off adhesion value was less than 5 MPa and an adhesive break pattern had occurred between the two layers of the test specimen. Otherwise, the intercoat adhesion was rated as “good”.

As a measure of the thermal shock resistance, a steel sheet (blasted steel SA 2%, surface roughness 60-80 μm) 150×100×3 mm was coated by twice spraying a 220 μm wet film (=2×approx. 150 μm dry film, approx. 300 μm dry film overall) using a gravity spray gun, with a wait time of 24 hours observed between the layers. The test specimens thus produced were stored for 7 days under standard climate conditions and then underwent 20 cycles in accordance with DIN EN ISO 19277 between an air-circulation oven at 204° C. and ice-water, in which the test specimens were stored in the air-circulation oven at 204° C. and once every 24 hours taken out of the oven and immediately immersed in a bucket of ice-water for 1 minute and then immediately returned to the air-circulation oven (=1 cycle). The test specimens were stored in the air-circulation oven over the weekend. After 20 cycles, the test specimens were cooled to room temperature and visually examined with a loupe to determine whether the coating was intact or had been destroyed, and whether cracks or flaking in the coating or corrosion on the steel sheet had occurred.

As a measure of the corrosion resistance, a test specimen produced in the same way as for the test for intercoat adhesion was stressed with condensation water in accordance with ISO 6270-1 for 720 h and then a pull-off adhesion test in accordance with ISO 4624 carried out at a test speed of 1 MPa/s. If the test specimen showed no signs of corrosion and the pull-off adhesion value was more than 6 MPa, the test was rated “very good”. A further identically produced test specimen was stressed for 1440 h with neutral salt spray in accordance with ISO 9227 and then a pull-off adhesion test in accordance with ISO 4624 carried out at a test speed of 1 MPa/s, with the test rating evaluated as described for stressing with condensation water.

The results are reported in Table 3.

TABLE 3
Composition and properties of examples 12 to 13.

| Example | 12 | 13 |
|---|---|---|
| Resin component: | | |
| Epilox ® N 18-10 | 21.0 | 21.0 |
| Xylene | 10.0 | 10.0 |
| Zinc pigment | 10.0 | 10.0 |
| Talc | 39.0 | 39.0 |
| Pigment paste | 10.0 | 10.0 |
| n-Butanol | 10.0 | 10.0 |
| Curing agent component: | | |
| Adduct A1 | 11.5 | — |
| Adduct A2 | — | 11.5 |
| Appearance | nice | nice |
| Intercoat adhesion | good | good |
| Thermal shock resistance: | passed | passed |
| Corrosion resistance: | | |
| Condensation water: | very good | very good |
| Salt spray: | very good | very good |

1. An amine-functional adduct from the reaction of
at least one amine of the formula (I),
Z—NH-A-NH—CH₂—Y (I)
where
A is a divalent alkylene, cycloalkylene or arylalkylene radical having 2 to 15 carbon atoms,
Z is H or —CH₂—Y, and
Y is H or an alkyl, cycloalkyl, aralkyl or aryl radical having 1 to 11 carbon atoms,
wherein the two nitrogen atoms to which the A radical is attached are separated from one another by at least two carbon atoms and the amine of the formula (I) contains a total of at least 8 carbon atoms,
with at least one novolak epoxy resin having an average functionality in the range from 2.5 to 4.

2. The adduct as claimed in claim 1, wherein A is selected from the group consisting of 1,2-ethylene, 1,2-propylene, 1,3-propylene, 1,4-butylene, 1,3-butylene, 2-methyl-1,2-propylene, 1,3-pentylene, 1,5-pentylene, 2,2-dimethyl-1,3-propylene, 1,6-hexylene, 2-methyl-1,5-pentylene, 1,7-heptylene, 1,8-octylene, 2,5-dimethyl-1,6-hexylene, 1,2-cyclohexylene, 1,3-cyclohexylene, 1,4-cyclohexylene, 4(2)-methyl-1,3-cyclohexylene, 1,3-cyclohexylene bis(methylene), and 1,4-cyclohexylenebis(methylene).

3. The adduct as claimed in claim 1, wherein Y is selected from the group consisting of H, methyl, ethyl, propyl, isopropyl, butyl, pentyl, heptyl, hept-2-yl, phenyl, 4-methylphenyl, 1-naphthyl, and cyclohexyl.

4. The adduct as claimed in claim 1, wherein Z is H or that the amine of the formula (I) is a mixture comprising an amine of the formula (I) where Z═H and an amine of the formula (I) where Z═—CH₂—Y.

5. The adduct as claimed in claim 1, wherein A is 1,2-ethylene and Y is phenyl.

6. The adduct as claimed in claim 1, wherein the novolak epoxy resin is a phenol-formaldehyde novolak glycidyl ether.

7. The adduct as claimed in claim 1, wherein the reaction takes place in a stoichiometric ratio of less than 3 mol of amine of the formula (I) to 1 molar equivalent of epoxy groups of amine of the formula (I) to 1 molar equivalent of epoxy groups.

8. The adduct as claimed in claim 1, wherein it contains oligomeric compounds of the formula (III), 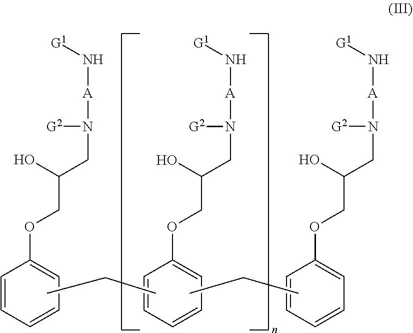
where
n on average has a value in the range from 0.5 to 3, and
G¹ and G² are Z, with the proviso that at least one of the two is —CH₂—Y.

9. The adduct as claimed in claim 1, wherein it has a viscosity at 20° C. in the range from 5 to 500 Pa·s, measured using a cone-plate viscometer at a shear rate of 10 s⁻¹.

10. A curing agent for epoxy resins comprising at least one adduct as claimed in claim 1 and at least one further constituent selected from the group consisting of further amines, accelerators, and thinners.

11. The curing agent as claimed in claim 10, wherein at least one further amine selected from the group consisting of N-benzylethane-1,2-diamine, N,N′-dibenzylethane-1,2-diamine, 1,5-diamino-2-methylpentane, 2,2(4),4-trimethylhexane-1,6-diamine, 1,2-diaminocyclohexane, 1,3-bis(aminomethyl)cyclohexane, 1,4-bis(aminomethyl)cyclohexane, bis(4-aminocyclohexyl)methane, 1-amino-3-aminomethyl-3,5,5-trimethylcyclohexane, 2(4)-methyl-1,3-diaminocyclohexane, 1,3-bis(aminomethyl)benzene, diethylenetriamine, triethylenetetramine, tetraethylenepentamine, N-(2-aminoethyl)propane-1,3-diamine, N,N′-bis(3-aminopropyl)ethylenediamine, dipropylenetriamine, bis(hexamethylene)triamine, polyoxypropylene diamines having an average molecular weight Mₙ in the range from 200 to 500 g/mol, and polyoxypropylene triamines having an average molecular weight Mₙ in the range from 300 to 500 g/mol is present.

12. The curing agent as claimed in claim 10, wherein 5 to 70% of all amine hydrogens present originate from the adduct.

13. An epoxy resin composition comprising
a resin component comprising at least one epoxy resin and
a curing agent component comprising at least one adduct as claimed in claim 1 or a curing agent for epoxy resins comprising at least one adduct as claimed in claim 1 and at least one further constituent selected from the group consisting of further amines, accelerators, and thinners.

14. A coating, primer, adhesive, sealant, potting compound, casting resin, impregnating resin or matrix for fiber composites, comprising the epoxy resin composition as claimed in claim 13.

15. An article comprising the coating, primer, adhesive, sealant, potting compound, casting resin, impregnating resin or matrix for fiber composites as claimed in claim 14.
